(19) United States
(12) Patent Application Publication
(10) Pub. No.: US 2018/0219698 A1
(43) Pub. Date: Aug. 2, 2018

(54) SYSTEM AND METHOD OF ORGANIZING AN ACTIVITY BASED ON USER PREFERENCES

(71) Applicant: Leigh M. Rothschild, Miami, FL (US)

(72) Inventor: Leigh M. Rothschild, Miami, FL (US)

(21) Appl. No.: 15/885,867

(22) Filed: Feb. 1, 2018

Related U.S. Application Data
(60) Provisional application No. 62/453,310, filed on Feb. 1, 2017.

(51) Int. Cl. H04L 12/28; G06F 3/01; H04W 4/021; H04W 4/80

(52) U.S. Cl. CPC H04L 12/2829; G06F 3/017; G06F 3/011; H04W 4/80; H04W 4/021

(57) ABSTRACT

A system and a method for organizing an activity based on user set preferences are disclosed. The method is executed based on an algorithm stored in a memory of the system. The method comprises accepting detecting a user device present in a vicinity of the system. The user device may be determined using a proximity sensor. The method further comprises identifying if the user device is detected for a first time. The user device is registered if detected for the first time. The unidentified user device is registered by storing a user identity (UID) and user preferences of a user operating the user device. The stored user preferences of the user may be executed to organize the activity.

### FIELD OF THE DISCLOSURE

The present disclosure is generally related to manage a task based on a user preference.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

A user needs to perform several tasks in order to manage things around him. Many of those tasks are repetitive in nature. For an example, a user pressing a button of a same floor everyday in his office building is one such case. In another case, the user chooses a cappuccino everyday on a coffee vending machine at his home or office. Further such tasks could not be automated based on a day and time setting as they require presence of a user in the environment.

Thus, there lies an immense need for organizing activities for a user, in a specific environment, after verifying his presence in the specific environment.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e. g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a network connection diagram 100 of a system 104 for organizing an activity based on user set preferences, according to an embodiment.

FIG. 2 illustrates a flowchart 200 of a method of organizing an activity based on user set preferences, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

A system 104 may be implemented as a local hardware or a remote hardware. The system 104 may be present as a single processing system or a group of systems programmed for providing at least one service. The system 104 may comprise a processor 110, memory 112, and interface(s) 114.

The processor 110 may execute an algorithm stored in the memory 112. The processor 110 may also be configured to decode and execute any instructions received from one or more other electronic devices or one or more servers. The processor 110 may include one or more general purpose processors (e.g., INTEL microprocessors) and/or one or more special purpose processors (e.g., digital signal processors or Xilinx System On Chip (SOC) Field Programmable Gate Array (FPGA) processor). The processor 110 may be configured to execute one or more computer-readable program instructions, such as program instructions to carry out any of the functions described in this description.

The memory 112 may include, but is not limited to, fixed (hard) drives, magnetic tape, floppy diskettes, optical disks, compact disc read-only memories (CD-ROMs), and magneto•optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine•readable medium suitable for storing electronic instructions.

The interface(s) 114 may be used to communicate with a user. The interface(s) 114 may be used either to accept an input from the user or to provide an output to the user, or performing both the actions. The interface(s) 114 may either be a Command Line Interface (CLI) or a Graphical User Interface (GUI).

A communication network 106 may be implemented using at least one communication technique selected from Visible Light Communication (VLC), Worldwide Interoperability for Microwave Access (WiMAX), cellular, Long term evolution (LTE), Wireless local area network (WLAN), Infrared (IR) communication, Public Switched Telephone Network (PSTN), Integrated Services Digital Network (ISDN), Broadband, Optical Fibre network, Radio waves, and/or other known communication techniques.

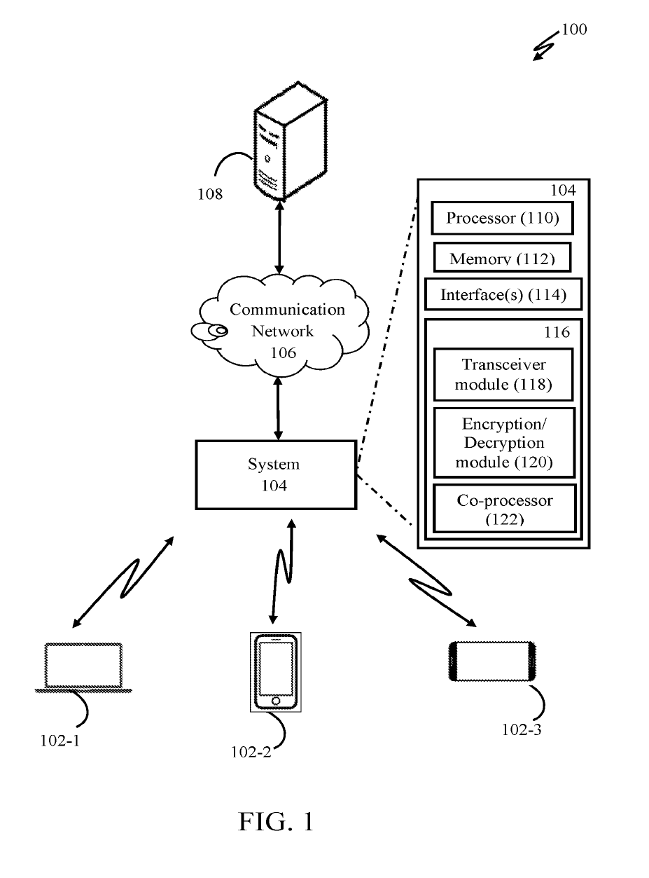

FIG. 1 illustrates a network connection diagram 100 of the system 104 for organizing an activity based on user set preferences, according to an embodiment. FIG. 1 comprises a user devices like a laptop 102-1, smart phone 102-2, and a tablet 102-3 connected to the system 104. The system 104 may be connected to the communication network 106. The communication network 106 may be connected to a server 108. The server 108 may be using Database Management Services (DBMS) such as Oracle™, Microsoft™ Structured Query Language (SQL), and others.

In one embodiment, a user may carry a user device with him. The user device could be any portable device like a laptop 102-1, smart phone 102-2, tablet 102-3, and any other device. In one case, the user may carry the smart phone 102-2 with him and may come near the system 104. When present in vicinity, the system 104 may detect the user device 102-2 using a proximity device, as illustrated at step 202. The proximity sensor may be one of a capacitive sensor, inductive sensor, magnetic sensor, photo sensor, Hall effect sensor, and ultrasonic sensor. The range of detection may depend on a type of proximity sensor used by the system 104.

In one embodiment, the user device may be detected by the system 104 using techniques including but not limited to Bluetooth, Near Field Communication (NFC), Wireless Fidelity (Wi•Fi), Infrared (IR), Radio Frequency Identification (RDID), and Global Positioning System (GPS). Any such technique may be used to detect the user device, based on a range of detection of the technique.

In one embodiment, the system 104 may determine if the user device is detected for a first time, at step 204, using an algorithm running on the processor 110. During such case, the system 104 may communicate with the user device to receive an identity of the user device. The identity of the user device may be a user identity (UID) of the user operating the user device, permanently stored in the user device. The user device may be identified as a known device when the system 104 identifies the UID. Further, when the UID is not identified by the system 104, the user device may be identified to be detected for the first time.

In one embodiment, the user device may be found to be detected for the first time. During such case, the system 104 may register the user device, at step 206, using the algorithm running on the processor 110. For registering the user device, the system 104 may accept the UID and user preferences of the user. The UID may be any of an employee ID, user's address, user's Email ID, user's account credentials, user's phone number, phone's Bluetooth address, International Mobile Equipment Identity (IMEi) number of user's phone, user's driving license number, user's Permanent Account Number (PAN) and any other unique identifier of the user.

In one embodiment, the user may provide his user preferences to the system 104 using the user device. In one case, the user may operate a User Interface (UI) on the user device for setting the user preferences. For an example, the user may be provided with a questionnaire comprising questions and their options to be chosen, on the UI. The user may set his preferences by answering such questions. In one example, the user may be asked about ‘floor number to be visited in an office building’ and the user may select floor 3 as an answer. Thus, third floor may be set as the user's preference of floor number in the office building. In another example, the user may be asked about ‘a type of drink preferred at home’ and the user may respond with a hot coffee. Thus, hot coffee may be set as the user preference for the type of drink preferred by the user at home.

In one embodiment, conditional user preferences may be set by the user. The conditional user preferences may be set based on time, date, date, temperature, weather, lighting conditions, and other factors. For example, the user may set his preference for the type of drink at home, as cold coffee during daytimes and hot coffee during nights.

In one embodiment, the user preferences may be stored along with the UID of the user. The UID may be stored in an encrypted format. In one case, the user preferences may be stored in the memory 112 of the system 104. In another case, the user preferences may be stored in a memory present remotely from the system 104. Such memory may be a part of the server 108 and may be connected to the system 104 through the communication network 106. Post registering the user, the system 104 may retrieve the user preferences, stored either in the memory 112 or the memory of the server 108. Successively, the user preferences may be executed, at step 208, using the algorithm running on the processor 110.

In one embodiment, the system 104 may comprise a dedicated chip/Integrated Circuit (IC) 116. The IC 116 may comprise an encryption/decryption module 120. The encryption/decryption module 120 may encrypt the UID using existing encryption algorithms such as Rivest Shamir Adleman (RSA), Triple Data Encryption Standard (DES), Blowfish, Twofish, Advanced Encryption Standard (AES) and the like. The UID may be encrypted using an encryption technique of order 32-bit, 64-bit or higher. The encryption/decryption module 120 may also be used to decrypt an encrypted UID.

In one embodiment, the IC 116 may comprise a co-processor 122 to regulate the flow of information between different modules of the IC 116. The IC 116 may also comprise an onboard memory for storing the UID's and user preferences. Further, the IC 116 may comprise at least one interface to connect with the processor 110. The IC 116 may also comprise a transceiver module 118 to connect with the server 108, through the communication network 106. The transceiver module 118 may operate using any of the communication techniques mentioned above, to send or receive the UID's and the user preferences.

In a first example, the user may enter into a lift of his office's building. The system 104 may be connected to a control circuit of the lift. The system 104 may detect presence of the user inside the lift using the proximity sensor. For a first time, the system 104 may accept a user's input of floor number. The user pressing a third floor button on a button panel of the lift may be accepted as a user preference, and may be stored.

In an alternate embodiment, the user may use a UI on the user device to set third floor as the user preference. Further, the user preference may also be provided using a keyboard, buttons, mouse, hand gesture, touch screen, and voice of the user. Further, any other known method or, device, different form the ones mentioned above, may also be used for providing the user preferences. The system 104 may store the user preference along with a UID of the user. Successively, the user may enter into the lift for a next time. In such case, the system 104 may already be aware of the third floor as the user preference of floor number. The control circuit of the lift, without receiving an input from the user, may set the third floor as a destination of the user and may open doors of the lift on the third floor.

In a second example, a user may operate a beverage vending machine at home. The user may set his preference as hot coffee, either by using the UI on the user device or by operating the beverage vending machine. The user preference of hot coffee may be stored by the system 104 present in the beverage vending machine. When the user comes near the beverage vending machine for a next time, a hot coffee may be served to him without operating the beverage vending machine.

In a third example, while the user preference of hot coffee is already set in the beverage vending machine, the system 104 may ask the user before serving a hot coffee to him. The user's input may act as a trigger and may be accepted using the user device or by operating the beverage vending machine. In such scenario, the user may change and may set cold coffee as his new preference. Further, the user preference may also be modified using other input means such as the keyboard, buttons, mouse, hand gesture, touch screen, voice of the user, and other known input providing means.

The above described methodology may be used in several other applications including but not limited to booking of movie tickets, ordering food and grocery, managing operation of electronic appliances or consumer electronic devices, setting of indoor and outdoor environments.

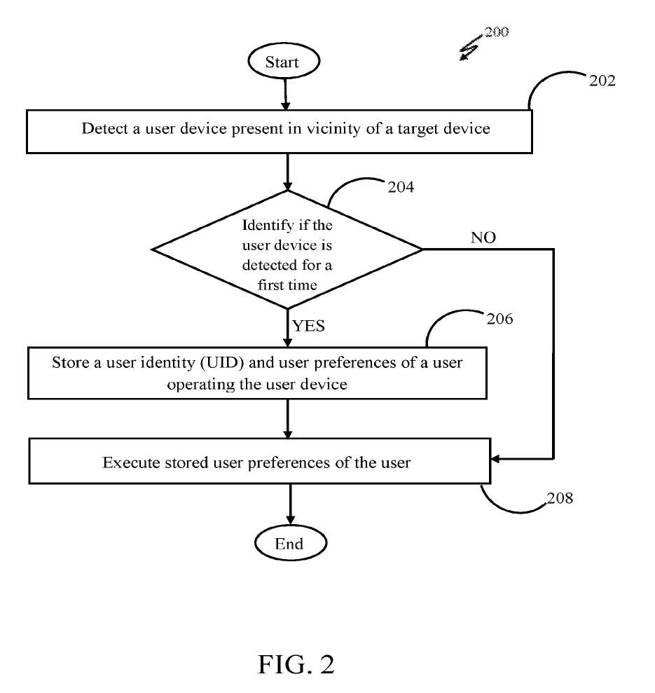

FIG. 2 illustrates a flowchart 200 of a method of organizing an activity based on user set preferences, according to an embodiment. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 208.

At step 202, a user device present in vicinity of a system 104 may be detected. In one embodiment, the user device may be detected by a proximity sensor.

At step 204, it may be identified if the user device is detected for a first time. In one embodiment, such identification may be performed by the processor 110.

At step 206, a user identity (UID) and user preferences of a user operating the user device may be stored, while the user device gets detected for the first time. In one embodiment, the user identity (UID) and the user preferences may be stored by the processor 110.

At step 208, stored user preferences may be executed. In one embodiment, the stored user preferences may be executed by the processor 110.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto•optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine•readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e. g., a modem or network connection).

What is claimed is:

1. A computer implemented method of organizing an activity based on user set preferences, the computer implemented method being executed on a system and comprising:
detecting, by a proximity sensor, a user device present in a vicinity of the system;
identifying the user device and registering an unidentified user device detected for a first time, wherein the unidentified user device is registered by storing a user identity (UID) and user preferences of a user operating the user device; and
executing the stored user preferences of the user, to organize the activity.

2. The method of claim 1, wherein the proximity sensor is one of a capacitive sensor, inductive sensor, magnetic sensor, photo sensor, Hall effect sensor, and ultrasonic sensor.

3. The method of claim 1, wherein the proximity sensor is implemented using a technique selected from a group consisting of Wireless Fidelity (Wi-Fi), Bluetooth, Near Field Communication (NFC), Radio Frequency Identification (RFID), and Global Positioning System (GPS).

4. The method of claim 1, wherein the UID is stored in an encrypted format.

5. The method of claim 1, wherein the user preference is provided using at least one of a keyboard, buttons, mouse, touch screen, and voice of the user.

6. The method of claim 1, wherein the user preference is provided using a gesture of at least one hand of the user.

7. The method of claim 1, further comprising storing the user preference in at least one of a memory of the system and a memory of a remote device.

8. The method of claim 1, further comprising modifying the user preferences of a user operating the user device.

9. The method of claim 1, further comprising receiving a trigger from a user device for executing the stored user preferences.

10. A system for organizing an activity based on user set preferences, the system comprising:
a processor; and
a memory coupled to the processor, wherein the processor executes an algorithm stored in the memory to:
detect, using a proximity sensor, a user device present in a vicinity of the system;
identify the user device and register an unidentified user device detected for a first time, wherein the unidentified user device is registered by storing a user identity (UID) and user preferences of a user operating the user device; and
execute the stored user preferences of the user, to organize the activity.

11. The system of claim 10, wherein the proximity sensor is one of a capacitive sensor, inductive sensor, magnetic sensor, photo sensor, Hall effect sensor, and ultrasonic sensor.

12. The system of claim 10, wherein the proximity sensor is implemented using a technique selected from a group consisting of Wireless Fidelity (Wi-Fi), Bluetooth, Near Field Communication (NFC), Radio Frequency Identification (RFID), and Global Positioning System (GPS).

13. The system of claim 10, wherein the UID is stored in an encrypted format.

14. The system of claim 10, wherein the user preference is provided using at least one of keyboard, buttons, mouse, touch screen, and voice of the user.

15. The system of claim 10, wherein the user preference is provided using a gesture of at least one hand of the user.

16. The system of claim 10, further comprising storing the user preference in at least one of a memory of the system and a memory of a remote device.

17. The system of claim 10, further comprising modifying the user preferences of a user operating the user device.

18. The system of claim 10, further comprising receiving a trigger from a user device for executing the stored user preferences.

19. The system of claim 10, further comprising a dedicated Integrated Circuit (IC) comprising:
a transceiver module for transmitting and receiving the UID and the user preferences of the user to a remote memory;
an encryption/decryption module for encrypting and decrypting the UID and the user preferences; and
a co-processor for regulating flow of information between the transceiver module and the encryption/decryption module.

20. The dedicated IC of claim 19, further comprising an on-board memory for storing the UID and the user preferences.

21. A system for organizing an activity based on user set preferences, the system comprising:
a processor coupled with a memory, the processor executing an algorithm stored in the memory to:
detect, using a proximity sensor, a user device present in a vicinity of the system;
receive user preferences of a user, operating the user device, while the user is identified for a first time;
register the user preferences in a memory of a remote server by storing the user preferences against a User Identity (UID) of the user; and
retrieve, to execute, the user preferences from the remote server for organizing the activity.
